(19) United States
(12) Patent Application Publication
(10) Pub. No.: US 2024/0375331 A1
(43) Pub. Date: Nov. 14, 2024

(54) INJECTION MOLD FOR MANUFACTURING GOLF BALLS AND GOLF BALLS MANUFACTURED BY USING THE SAME

(71) Applicant: FENG TAY ENTERPRISES CO., LTD., Douliou City (TW)

(72) Inventor: Chin-Shun Ko, Douliou City (TW)

(73) Assignee: FENG TAY ENTERPRISES CO., LTD., Douliou City (TW)

(21) Appl. No.: 18/195,885

(22) Filed: May 10, 2023

(51) Int. Cl. B29C 45/27; A63B 37/00

(52) U.S. Cl. CPC B29C 45/27; A63B 37/0033; A63B 37/0045; A63B 37/0087; A63B 37/0074; A63B 37/0075; A63B 37/0076; B29C 2045/2683; B29L 2031/546

(57) ABSTRACT

An injection mold for golf balls includes a first mold half and a second mold half, which could be removable mated with each other, and a spherical cavity and a runner system are disposed therebetween. The runner system includes a primary runner corresponding to an annular runner surrounding the spherical cavity. Additionally, the injecting runners connect the annular runner and the spherical cavity. A sum of the cross-sectional area of the injecting runners near the primary runner is smaller than a sum of the cross-sectional area of the injecting runners away from the primary runner. Alternatively, a number of the injecting runners near the primary runner is smaller than a number of the injecting runners away from the primary runner. With such design, the plastic material could be evenly injected into the spherical cavity, and the sprue of the product could be reduced. A golf ball manufactured by using the injection mold is provided herewith.

### BACKGROUND OF THE INVENTION

### Technical Field

The present invention relates generally to a golf ball, and more particularly to an injection mold for manufacturing golf balls and golf balls manufactured by using the same.

### Description of Related Art

A conventional mold used in a process of manufacturing a golf ball includes a first mold half and a second mold half that could be removably mated with each other, wherein a parting line surface of the first mold half could be removably mated with a parting line surface of the second mold half. The first mold half and the second mold half usually have a symmetrical structure. Take the first mold half 1 shown in FIG. 1 as an example, the first mold half 1 has a parting line surface 1a, wherein a plurality of hemispherical recesses 1b is formed by recessing into the parting line surface, and each of the hemispherical recesses 1b is connected to one of primary runners 1c, an extending runner 1d, and two arched runners 1e. The primary runner 1c communicates with the extending runner 1d, and each of the two ends of the extending runner 1d is connected to one of the two arched runners 1e. Each of the arched runners 1e is connected to a plurality of injecting runners 1f and communicates with the hemispherical recess 1b via the injecting runners 1f. The primary runner 1c, the extending runner 1d, the arched runner 1e, and the injecting runner 1f constitute a runner system.

When the parting line surface of the first mold half is mated with the parting line surface of the second mold half, the hemispherical recesses of the first mold half and the hemispherical recesses of the second mold half are coupled to form spherical cavities. A ball body (not shown) is disposed in each of the spherical cavities in advance. The conventional mold is adapted to be connected to an injection molding machine (not shown), and the injection molding machine force the molten plastic into the spherical cavities through the primary runners 1c, the extending runners 1d, the arched runners 1e, and the injecting runners 1f sequentially, to finally cover the ball body in each spherical cavity. As illustrated in FIG. 2, after cooling down to solidify, the plastic material in the spherical cavity and the ball body jointly form a ball product G, and the plastic material filled in the primary runners 1c, the extending runners 1d, the arched runners 1e, and the injecting runners 1f jointly form a sprue F, wherein the sprue F is connected to the ball product G. After the connecting structure F is detached from the ball product G, the sprue F could be crushed for recycling or be treated as a waste.

The runners of the conventional mold are designed for allowing the molten plastic to evenly and smoothly flow into the hemispherical recess 1b. Each of the two ends of the extending runner 1d is connected to one of the arched runners 1e, wherein the arched runners 1e are symmetrical. Each of the arched runners 1e is connected to the same number of the injecting runners 1f that are spaced and arranged evenly. However, a total length of the runners of the design of the conventional mold becomes excessively long, so that the amount of the sprue F is consequentially increased. In order to reduce the amount of the sprue F, another conventional mold 2 is provided. The another conventional mold 2 has an annular runner 2a instead of two arched runners. As illustrated in FIG. 3 and FIG. 4, the annular runner 2a is connected to a plurality of injecting runners 2b that are spaced and arranged evenly, and the primary runner 2c is connected to the annular runner 2a, so that the extending runners could be omitted to reduce the total length of the runner system. However, in the another conventional mold, the molten plastic will first flow to the injecting runner 2b that is near to the primary runner 2c, and then flow to the injecting runners 2b that are away from the primary runner 2c. Thus, as the material is moving to the injecting runners 2b that are away from the primary runner 2c, the injecting pressure of the material is gradually reduced. In such situation, the flowing volume of the material at a side that is near the primary runner 2c will be greater than the flowing volume of the material at a side that is away from the primary runner 2c, so that a surface of the ball body 3 cannot be covered by the molten plastic simultaneously and evenly. In other words, the molten plastic injected through the injecting runners 2b near the primary runner 2c will extend along the surface of the ball body 3 earlier than the molten plastic injected through the injecting runners 2b away from the primary runner 2c, so that the molten plastic injected from different injecting runners 2b cannot ideally be gathered at polar areas (north or south pole area) A1 of the hemispherical recesses, wherein the polar areas are bottom portions of the hemispherical recesses, but gathered at another area A2 away from the polar areas A1. The venting channel 2d allows the air in the spherical cavity to be discharged when the molten plastic is injected. Since the venting channel 2d is disposed within the polar areas of the hemispherical recesses, when the injected molten plastic is gathered at the another area A2 that is away from the polar areas A1, the air in the spherical cavity is probably stuck inside, leading to bubble problem in the final ball product. Besides, since the molten plastic is not injected into the spherical cavity in a balanced way, a thickness of the injected layer can be different around the ball body, leading to off-center problem.

### BRIEF SUMMARY OF THE INVENTION

In view of the above, the primary objective of the present invention is to provide an injection mold for a golf ball, which could reduce the amount of the sprue and promote the yield of the golf ball.

The present invention provides an injection mold, including a first mold half, a second mold half, and a runner system. Each of the mold halves has a parting line surface and at least one inner surface that is recessed into the parting line surface. When the parting line surface of the first mold half is mated with the parting line surface of the second mold half, the inner surface of the first mold half and the inner surface of the second mold half are coupled to form a spherical cavity. The runner system includes a primary runner, an annular runner, and at least one injecting runner, wherein plastic material flows through the primary runner into the annular runner, and the annular runner is formed on the parting line surface of the first mold half and/or the parting line surface of the second mold half. The annular runner surrounds the spherical cavity. The at least one injecting runner formed on the parting line surface of the first mold half and/or the parting line surface of the second mold half, and the at least one injecting runner connects between the annular runner and the spherical cavity. An area of a connecting site between the at least one injecting runner and the spherical cavity is defined as a cross-sectional area of the at least one injecting runner. A phantom coronal plane is defined to pass through the injection mold to divide the first mold half and the second mold half into a proximal portion and a distal portion. The proximal portion includes the primary runner and a part of the at least one injecting runner. The distal portion includes the other part of the at least one injecting runner; wherein a sum of the cross-sectional area of the at least one injecting runner in the proximal portion is p, and a sum of the cross-sectional area of the at least one injecting runner in the distal portion is d. A ratio of d/p is greater than 1.

Additionally, the present invention provides another injection mold, including a first mold half, a second mold half, and a runner system. Each of the mold halves has a parting line surface and at least one inner surface that is recessed into the parting line surface. When the parting line surface of the first mold half is mated with the parting line surface of the second mold half, the inner surface of the first mold half and the inner surface of the second mold half are coupled to form a spherical cavity. The runner system includes a primary runner, an annular runner, and a plurality of injecting runners, wherein plastic material flows through the primary runner into the annular runner, and the annular runner is formed on the parting line surface of the first mold half and/or the parting line surface of the second mold half. The annular runner surrounds the spherical cavity. The plurality of injecting runners formed on the parting line surface of the first mold half and/or the parting line surface of the second mold half, and the plurality of injecting runners connect between the annular runner and the spherical cavity. A phantom coronal plane is defined to pass through the injection mold to divide the first mold half and the second mold half into a proximal portion and a distal portion. A number of the injecting runners in the proximal portion is smaller than a number of the injecting runners in the distal portion, and the proximal portion comprises the primary runner.

Since the injection mold fulfills the condition that the sum of the cross-sectional area of the injecting runners communicating with the spherical cavity near the primary runner is smaller than the sum of the cross-sectional area of the injecting runners away from the primary runner, the plastic material could be evenly injected into the spherical cavity and the amount of the sprue could be reduced. Alternatively, when the injection mold fulfills the condition that the number of the injecting runners near the primary runner is smaller than the number of the injecting runners away from the primary runner, the same efficacy could be achieved as well.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a top view of the conventional mold half for manufacturing golf balls;

FIG. 2 is a schematic view of the plastic product which is formed by using the mold shown in FIG. 1;

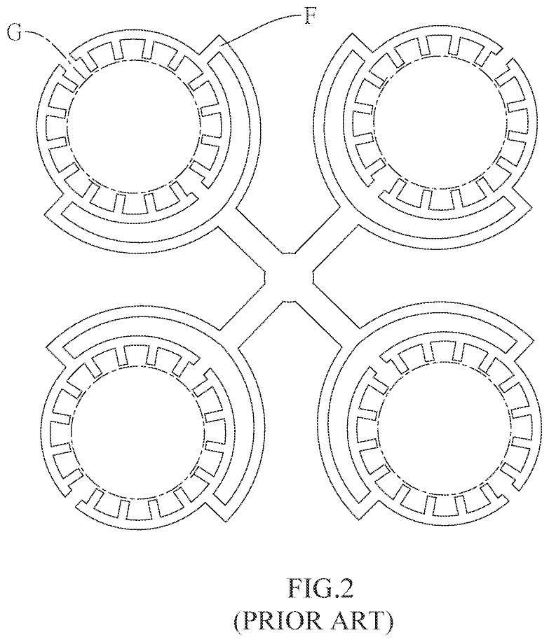

FIG. 3 is a top view of another conventional mold half for manufacturing golf balls;

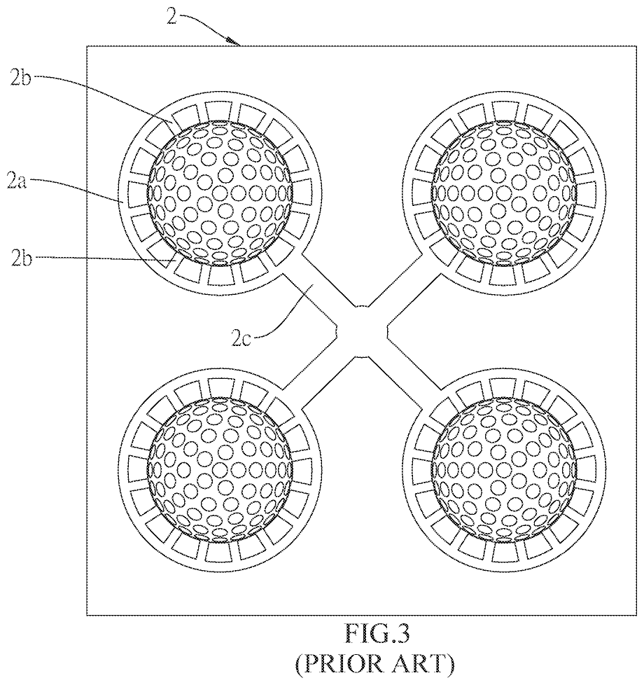

FIG. 4 is a sectional view of the another conventional mold in the closed status for manufacturing golf balls;

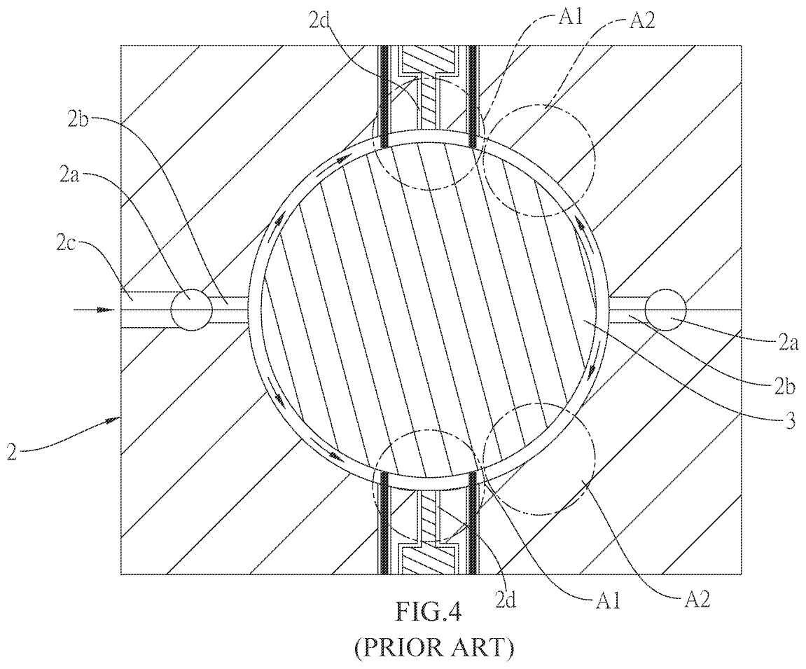

FIG. 5 is a perspective view of the mold for manufacturing golf balls of an embodiment according to the present invention;

FIG. 6 is a top view of the mold half of the mold for manufacturing golf balls of the embodiment according to the present invention;

FIG. 7A is a sectional perspective view of the golf ball of an embodiment according to the present invention, showing the golf ball is a two-piece ball;

FIG. 7B is a sectional perspective view of the golf ball of an embodiment according to the present invention, showing the golf ball is a multi-piece ball;

FIG. 8 is a sectional perspective view of the marked portion A of the mold in FIG. 5;

FIG. 9 is a sectional view taken along the 9-9 line in FIG. 8;

FIG. 10 is an enlarged partial view of the mold in FIG. 6, showing the arrangement of the runner system and the spherical cavity;

FIG. 11 is a schematic view, showing the arrangement of the injecting runner of the runner system and the spherical cavity;

FIG. 12A is a schematic view, showing the mold has six injecting runners at the proximal end;

FIG. 12B is a schematic view, showing the mold has twelve injecting runners at the distal end;

FIG. 13 is similar to FIG. 10, showing the arrangement of another injecting runner of the runner system and the spherical cavity;

FIG. 14 is a sectional view, showing the closed mold that includes the runner system shown in FIG. 13;

FIG. 15 is similar to FIG. 10, showing the arrangement of the runner system and the spherical cavity;

FIG. 16 is similar to FIG. 10, showing the arrangement of the runner system and the spherical cavity;

FIG. 17 is similar to FIG. 10, showing the arrangement of the runner system and the spherical cavity;

FIG. 18 is similar to FIG. 10, showing the arrangement of the runner system and the spherical cavity;

FIG. 19 is a sectional view, showing the closed mold that includes the runner system shown in FIG. 18; and

FIG. 20 is similar to FIG. 10, showing the arrangement of the runner system and the spherical cavity.

### DETAILED DESCRIPTION OF THE INVENTION

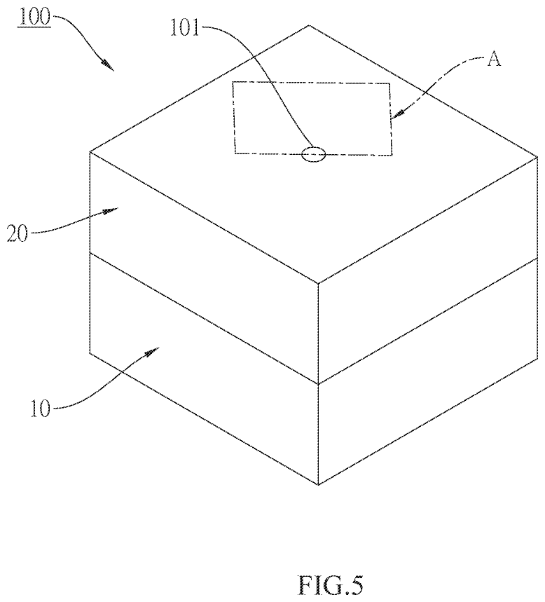

As illustrated in FIG. 5 to FIG. 8, an injection mold 100 for golf balls includes a first mold half 10 and a second mold half 20, which could be removably mated with each other, wherein a parting line surface 12 of the first mold half 10 is mated with a parting line surface 22 of the second mold half 20. The injection mold 100 for golf balls has a plurality of spherical cavities inside, wherein the spherical cavities are connected to each other via a runner system 30. The runner system 30 communicates with a main channel 101 that is adapted to be connected to an injection molding machine (not shown). The injection mold 100 for golf balls in the current embodiment works with a vertical injection molding machine, so that the main channel 101 is located at a top portion of the injection mold 100. However, in other embodiments, the main channel 101 of an injection mold could be disposed at a vertical side of the injection mold, thereby allowing the injection mold to work with a horizontal injection molding machine.

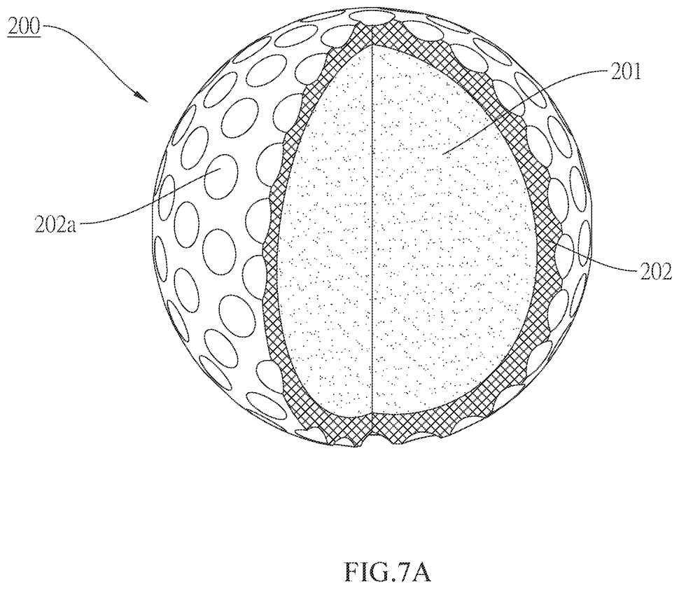

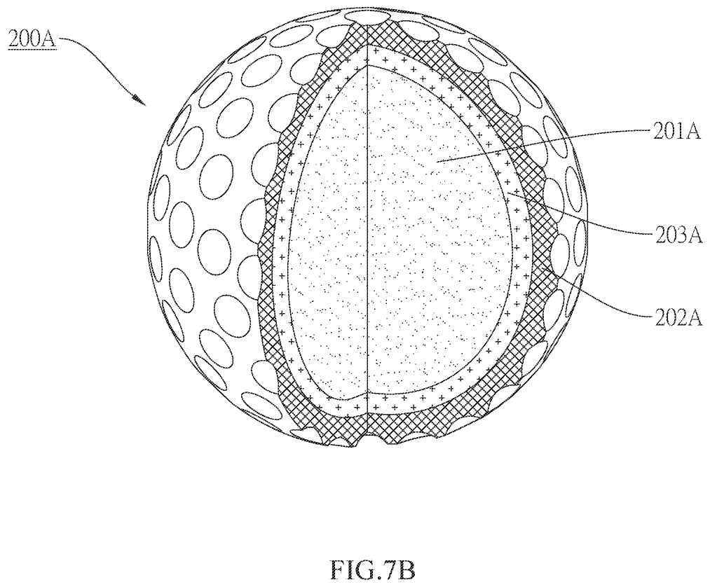

A ball body is disposed in the spherical cavity in advance. The plastic material is injected into the spherical cavities through the runner system 30 to enclose the ball body. After the plastic material is solidified, the plastic material that covers the ball body constitutes a part of a golf ball. When the golf ball is a two-piece ball (as shown in FIG. 7A), the ball body constitutes a core 201 of the golf ball 200, and the plastic material that is solidified constitutes a cover 202 of the golf ball 200. An outer surface of the cover 202 has a plurality of dimples 202a. As illustrated in FIG. 7B, when the golf ball is a multi-piece ball (more than two layers), the ball body constitutes a core 201A of the golf ball 200A, and the plastic material that is solidified constitutes a cover 202A of the golf ball 200A. Additionally, the plastic material that is solidified could also constitute an intermediate layer 203A between the core 201A and the cover 202A, wherein a number of the intermediate layer 203A is not limited to one. In general, the core 201 is made of a thermosetting material. However, in another embodiment, the core 201 could also be made of either a thermoplastic material or a mixture of thermosetting material and thermoplastic material on the required demand. The thermosetting material that is used for manufacturing the core 201, 201A could be selected from a group consisting of natural rubber, 1,4-cis-polybutadiene, polyisoprene, styrene-butadiene copolymer, polyurethane, and a combination thereof, but is not limited to the abovementioned materials. The thermoplastic material that is used for manufacturing the core 201, 201A could be selected from a group consisting of ionomer resin, highly neutralized acid polymer composition, polyamide resin, polyester resin, polyurethane resin, and a combination thereof, but is not limited to the abovementioned materials. When the core 201, 201A is made of the thermoplastic material, the core 201, 201A could be solid or foamed. When the core 201, 201A is a foamed structure, a proper blowing agent is added into the thermoplastic material. The blowing agent could be a physical blowing agent (e.g. supercritical fluid) or a chemical blowing agent (e.g. azo compound chemical blowing agent). A material for manufacturing the intermediate layer 203A could be selected from a group consisting of thermoplastic material, thermosetting material, or a mixture of thermoplastic material and thermosetting material. The thermoplastic material that is used for manufacturing the intermediate layer 203A could be selected from a group consisting of ionomer resin, highly neutralized acid polymer composition, polyamide resin, polyester resin, polyurethane resin, and a combination thereof, but is not limited to the abovementioned materials. The thermosetting material that is used for manufacturing the intermediate layer 203A could be selected from a group consisting of natural rubber, 1,4-cis-polybutadiene, polyisoprene, styrene-butadiene copolymer, polyurethane, and a combination thereof, but is not limited to the abovementioned materials. The cover 202, 202A is made of thermoplastic material that is selected from a group consisting of ionomer resin, highly neutralized acid polymer composition, polyamide resin, polyester resin, polyurethane resin, and a combination thereof, but is not limited to the abovementioned materials. Preferably, the cover 202, 202A is made of ionomer resin or polyurethane resin.

The following describes the technical features of the injection mold 100 for golf balls of the embodiment, which enable the plastic material to evenly flow into the spherical cavity and reduce an amount of the sprue of a molding product that is produced by using the injection mold 100.

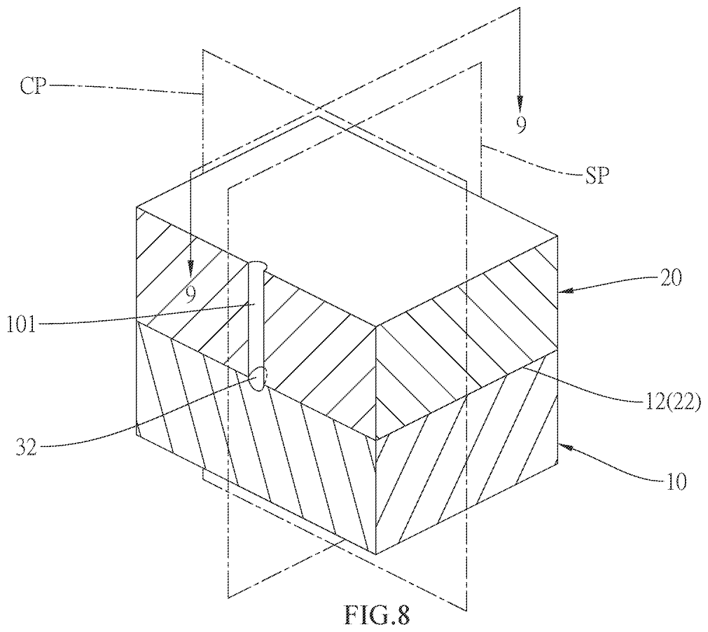

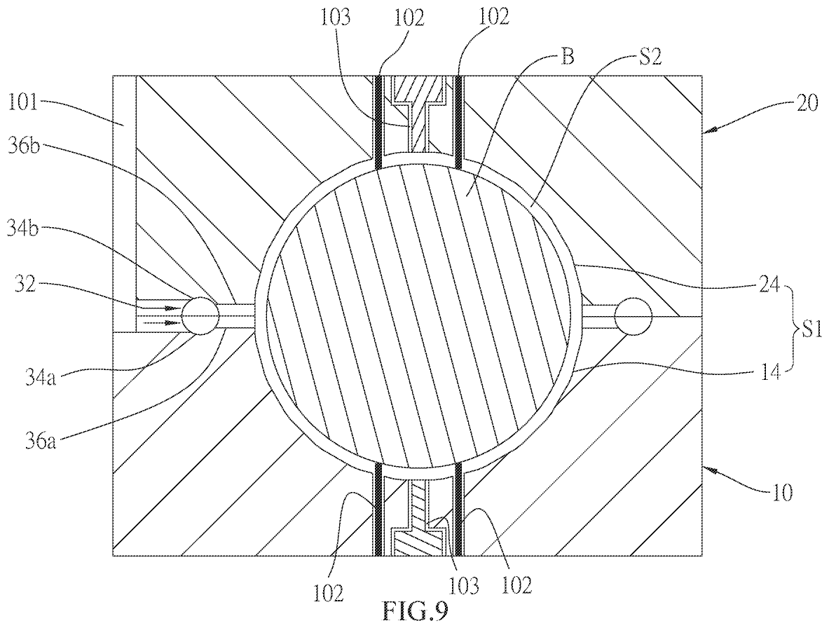

The first mold half 10 and the second mold half 20 have a symmetrical structure, thus the first mold half 10 is taken as an example in the following description for convenience. The first mold half 10 has a parting line surface 12, wherein the parting line surface 12 is recessed to form at least one inner surface. The inner surface constitutes a hemispherical recess 14. In the current embodiment, the hemispherical recess 14 includes a plurality of hemispherical recesses 14. As illustrated in FIGS. 8 to 10, when the parting line surface 12 of the first mold half 10 and a parting line surface 22 of the second mold half 20 are mated, each of the hemispherical recesses 14 on the first mold half 10 and the corresponding one of the hemispherical recesses 24 of the second mold half 20 jointly forms a spherical cavity S1. The ball body B in each of the spherical cavities S1 is supported by a plurality of supporting pins 102 to keep the ball body B at a position where the ball body B does not touch the inner surface of the spherical cavity S1, thereby defining an injecting space S2 formed between a surface of the ball body B and the inner surface of the spherical cavity S1. Additionally, a bottom portion of each of the hemispherical recesses 14, 24 of the first and second mold half 10, 20 is disposed with a venting channel 103, wherein the venting channel 103 communicates with the spherical cavity S1. Except for the venting channel 103, air in the spherical cavity S1 could be discharged through gaps between the supporting pins 102 and the first mold half 10 and gaps between the supporting pins 102 and the second mold half 20.

The runner system 30 is formed at a mating portion between the first mold half 10 and the second mold half 20. Each of the spherical cavities SI corresponds to a primary runner 32, an annular runner 34, and at least one injecting runner 36. The primary runners 32, the annular runners 34, and the injecting runners 36 constitute a runner system 30. An end of the primary runner 32 communicates with the main channel 101. The annular runner 34 is formed on the parting line surface 12 of the first mold half 10 or the parting line surface 22 of the second mold half 20. In another embodiment, the annular runner 34 is formed on both of the parting line surface 12 of the first mold half 10 and the parting line surface 22 of the second mold half 20. The annular runner 34 surrounds the spherical cavities S1. In the current embodiment, the at least one injecting runner 36 includes a plurality of injecting runners 36. The injecting runners 36 are formed on the parting line surface 12 of the first mold half 10 or the parting line surface 22 of the second mold half 20. In another embodiment, the injecting runners 36 is formed on both of the parting line surface 12 of the first mold half 10 and the parting line surface 22 of the second mold half 20. The injecting runners 36 communicate with the annular runner 34 and the spherical cavity S1.

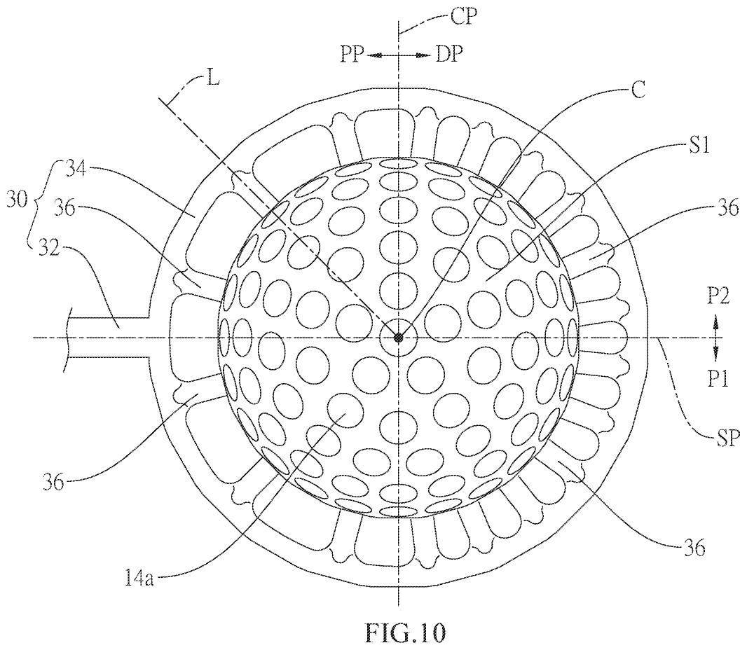

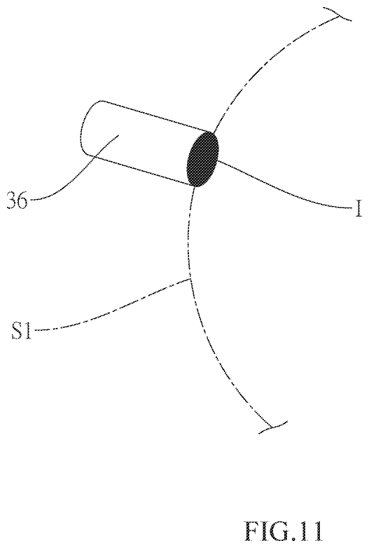

In an embodiment, an extending direction of the primary runner 32 (namely, a direction that the plastic material enters the annular runner 34) passes through a center C of the spherical cavity S1. The first mold half 10 has an annular groove 34a that is formed by recessing into the parting line surface 12 of the first mold half 10, and the second mold half 20 has an annular groove 34b that is formed by recessing into the parting line surface 22 of the second mold half 20. When the first mold half 10 is mated with the second mold half 20, the annular groove 34a on the first mold half 10 and the annular groove 34b of the second mold half 20 jointly formed the annular runner 34. The first mold half 10 has at least one shallow groove 36a that is formed by recessing into the parting line surface 12 of the first mold half 10, and the second mold half 20 has at least one hollow groove 36b that is formed by recessing into the parting line surface 22 of the second mold half 20. When first mold half 10 is mated with the second mold half 20, each of the at least one shallow groove 36a of the first mold half 10 and one of the at least one hollow groove 36b of the second mold half 20 jointly forms one injecting runner 36. The injecting runners 36 are arranged radially. Each of the injecting runners 36 is defined to have an extending line L that is parallel to a flowing direction of the plastic material, wherein the extending line L passes through the center C of the spherical cavity S1. Furthermore, an area of a connecting site I between each of the injecting runners 36 and the spherical cavity S1 is a cross-sectional area of the injecting runner 36 (as shown in FIG. 11). The cross-sectional area is in a range of 0.2 mm² to 2.0 mm². A phantom coronal plane CP is defined to be perpendicular to the extending direction of one of the primary runners 32 and to pass through the center C of the corresponding one of the spherical cavities S1. The phantom coronal plane CP divides the first mold half 10 and the second mold half 20 into a proximal portion PP and a distal portion DP. Since the first mold half 10 and the second mold half 20 have symmetrical structure, thus the first mold half 10 is taken as an example in the following description for convenience. As illustrated in FIG. 10, the proximal portion PP includes the primary runner 32 and a part of the injecting runners 36, and the distal portion DP includes the rest of the injecting runners 36. A sum of the cross-sectional area of the injecting runners 36 in the proximal portion PP is p, and a sum of the cross-sectional area of the injecting runners 36 in the distal portion DP is d, wherein p is smaller than d. In other words, a ratio of d/p (namely, a ratio of the area sum to the area sum) is greater than 1. The ratio of d/p is in a range of 2 to 6. Preferably, the ratio of d/p is in a range of 2 to 4.

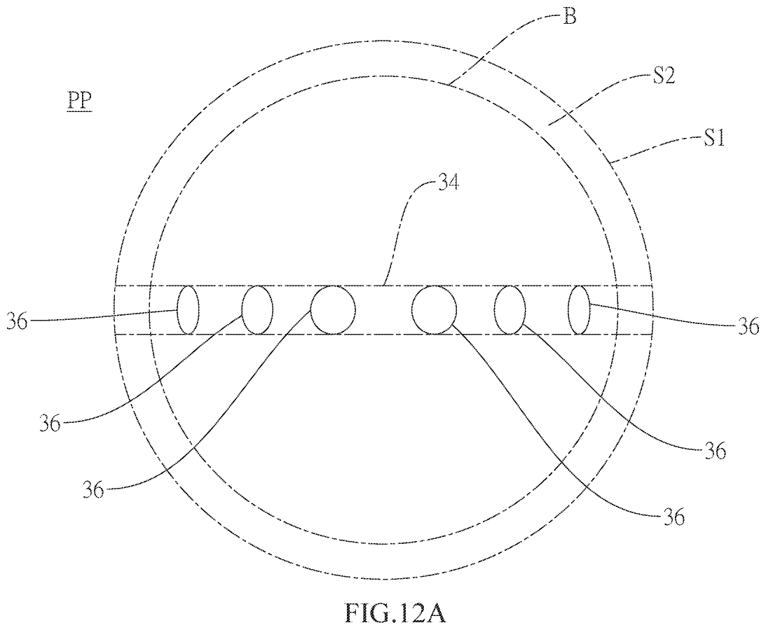

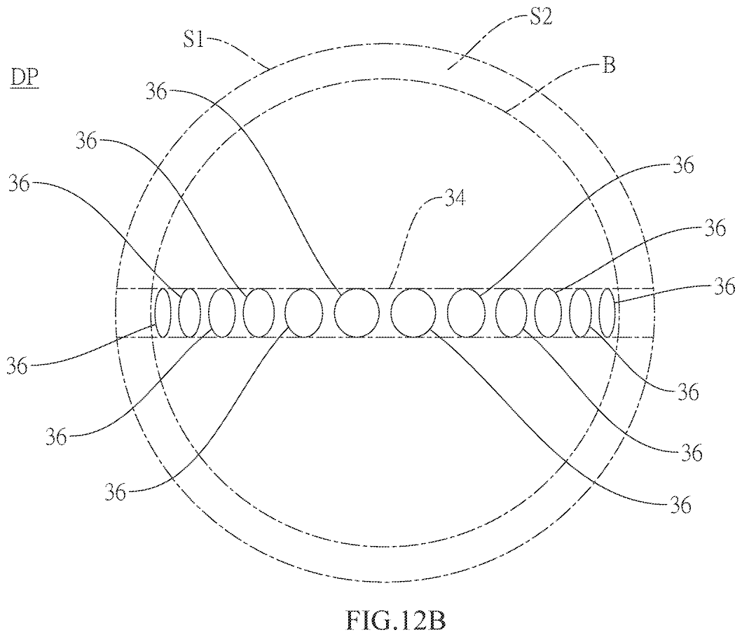

As illustrated in FIG. 10, the cross-sectional area of each of the injecting runners 36 in the proximal portion PP is substantially equal to the cross-sectional area of each of the injecting runners 36 in the distal portion DP. Therefore, the number of the injecting runners 36 in the proximal portion PP is smaller than the number of the injecting runners 36 in the distal portion DP to achieve the condition that the ratio of d/p is greater than 1. As illustrated in FIG. 12A and FIG. 12B, the proximal portion PP includes six injecting runners 36 that are arranged and spaced evenly, and the distal portion DP includes twelve injecting runners 36 that are arranged and spaced evenly. In such situation, the ratio of d/p is 2, which satisfies a condition that the sum (p) of the cross-sectional area of the injecting runners 36 in the proximal portion PP is smaller than the sum (d) of the cross-sectional area of the injecting runners 36 in the distal portion DP. Additionally, a total number of the injecting runners 36 on the proximal portion PP and the distal portion DP could be in a range of 6 to 40, preferably in a range of 9 to 30. When the number of the injecting runners 36 on the proximal portion PP is smaller than the number of the injecting runners 36 on the distal portion DP, the number of the injecting runners 36 on the proximal portion PP could be in a range of 2 to 12, and the number of the injecting runners 36 on the distal portion DP could be in a range of 4 to 28. Preferably, the number of the injecting runners 36 on the proximal portion PP could be in a range of 4 to 10, and the number of the injecting runners 36 on the distal portion DP could be in a range of 5 to 20.

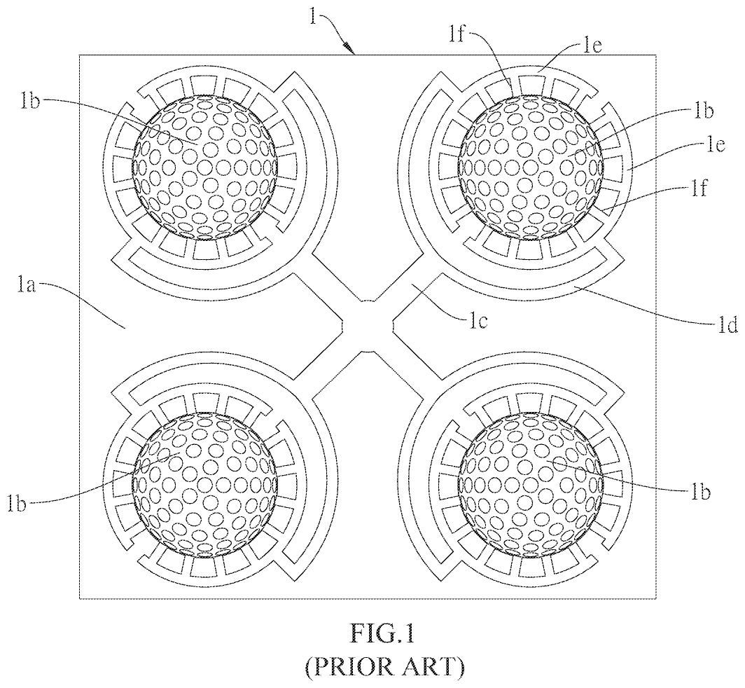

To sum up, the injecting runners 36 of the injection mold 100 for golf balls is designed to fulfill the condition that the sum of the cross-sectional area of the injecting runners 36 that is close to the primary runner 32 is smaller than the sum of the cross-sectional area of the injecting runners 36 that is away from the primary runner 32. Thus, when the plastic material enters into the injecting space S2 sequentially through the primary runner 32, the annular runner 34, and each of the injecting runners 36, the injecting pressure of the plastic material flowing in the injecting space S2 could be balanced, so that the plastic material could evenly flow into the spherical cavity S1 via the injecting runners 36 in the proximal portion PP and the distal portion DP to fill the injecting space S2. Namely, the plastic material that is injected through the injecting runners 36 in the injecting space S2 will finally gather at a polar areas A1, so that the air in the injecting space S2 could be smoothly discharged through the venting channel 103, thereby reducing bubble problem to a great extent. With such design, by using single primary runner and corresponding single annular runner with the injecting runners 36, the plastic material could be smoothly and evenly filled in the injecting space S2, thereby enhancing the yield rate of the golf ball. Additionally, each of the spherical cavity S1 corresponds to one primary runner 32, one annular runner 34, and a plurality of injecting runners 36, so that a total length of the primary runner 32, the annular runner 34, and the injecting runners 36 is shorter than the total length of the conventional runner system having extending runner 1d and two arched runners 1e shown in FIG. 1. Therefore, after the plastic material is cooled down and solidified, the sprue, which is formed by the plastic material in the runners, in the present invention is significantly reduced, thereby achieving the purpose of reducing the sprue in the injection molding product. Besides, since the total length of the runner system is reduced, the temperature drop of the plastic material could be reduced when the plastic material flows through the runner, so that the good fluidity of the plastic material could be maintained, thereby producing a ball shell (namely, the cover of the golf ball) that is thinner. Especially, when the plastic material of the cover of the golf ball is thermoplastic polyurethane (TPU) that has lower resilience, by reducing the thickness of the TPU cover of the golf ball and increasing the thickness of other layer with higher resilience to maintain the size of the golf ball, the resilience of the golf ball could be increased, thereby increasing the speed and the total distance of carry and roll of the golf ball. Moreover, since the total length of the runners is reduced, the injection temperature and the injection speed could set lower and slower, wherein the lower injection temperature and the slower injection speed could reduce the risk of forming bubbles and avoid the difficulty of demolding, thereby increasing the yield rate and reducing the manufacturing cost.

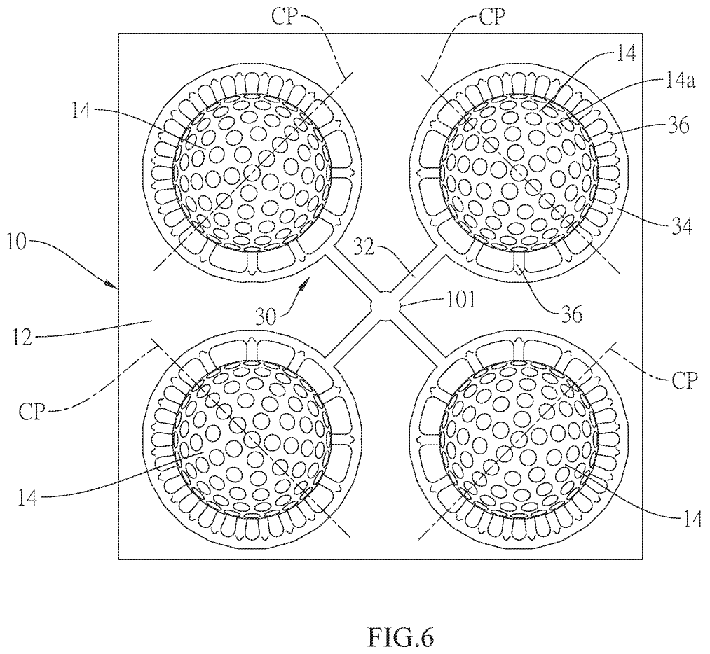

In the current embodiment, a diameter of each of the injecting runners 36 remains the same all the way, so that the cross-sectional area of each of the injecting runners 36 is consistent. When the plastic material is injected through the injecting runners 36 having a consistent diameter to fill the injecting space S2, the plastic material that is solidified is better to form an intermediate layer of the multi-layered golf ball, but it is not limited to the abovementioned. When the plastic material is used to form the intermediate layer of the golf ball, the inner surface of each of the hemispherical recesses 14 could be smooth or unsmooth, thereby forming the intermediate layer having either a smooth or an unsmooth outer surface. When the plastic material is used to form the cover of the golf ball, the inner surface of each of the hemispherical recesses 14 has a plurality circular or non-circular protrusion 14a (as shown in FIG. 6 and FIG. 10), thereby forming a plurality of dimples 202a on the cover of the golf ball.

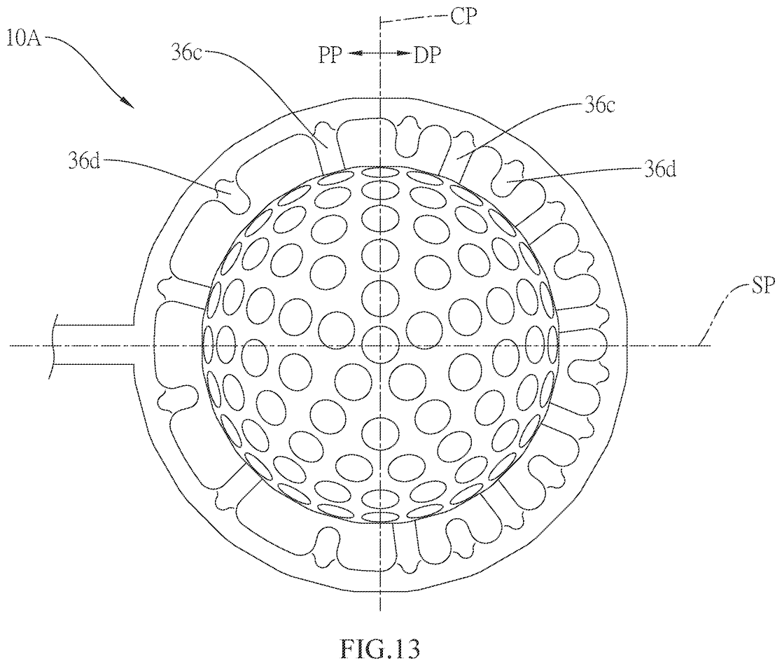

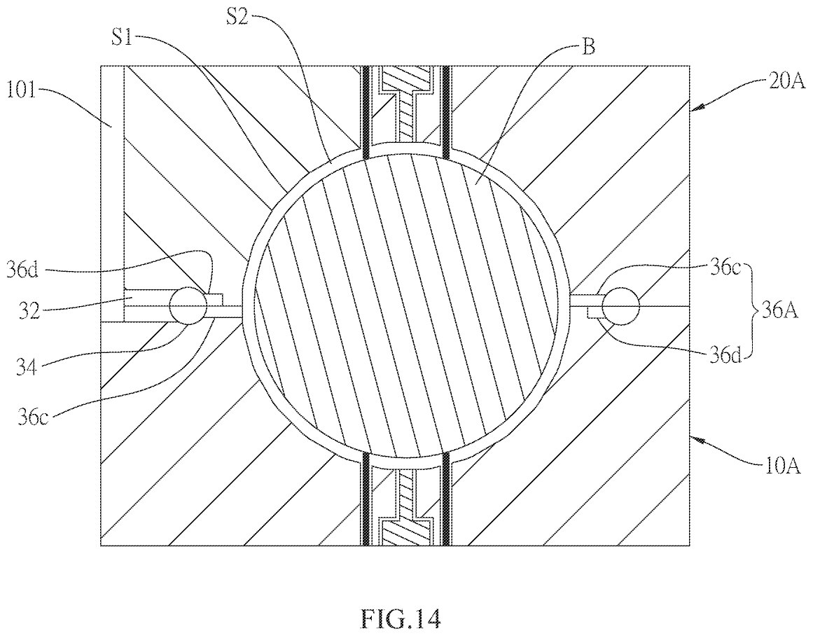

In the current embodiment, the shallow grooves 36a (36b) disposed on the parting line surface of the first mold half 10 and the second mold half 20 and used for constituting the injecting runners 36 directly communicates with the spherical cavity S1. In practice, the shallow grooves could partially communicate with the spherical cavity S1. Namely, a part of the shallow grooves communicate with the spherical cavity S1, and the rest part of the shallow grooves do not communicate with the spherical cavity S1. Take the first mold half 10A illustrated in FIG. 13 as an example, the parting line surface of the first mold half 10A is disposed with the shallow grooves, wherein a part of the shallow grooves 36c communicate with the spherical cavity S1, the rest part of the shallow grooves 36d do not communicate with the spherical cavity S1. When the first mold half 10A is mated with the second mold half 20A (as shown in FIG. 14), the shallow grooves 36c on the first mold half 10A that communicate with the spherical cavity S1 are respectively aligned with the shallow grooves 36d on the second mold half 20A that do not communicate with the spherical cavity S1, and the shallow grooves 36d of the first mold half 10A that do not communicates with the spherical cavity S1 are aligned with the shallow grooves 36c of the second mold half 20A that communicate with the spherical cavity S1, thereby forming the injecting runners 36A to allow the plastic material to evenly enter into the injecting space S2.

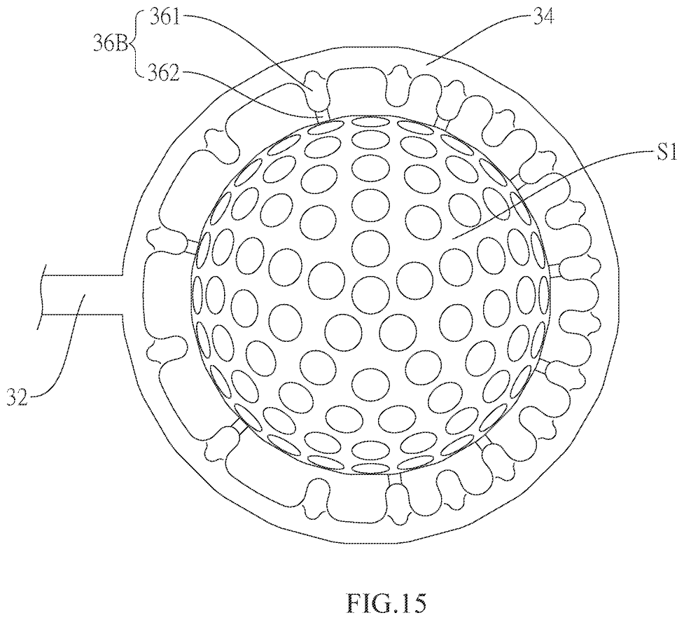

As illustrated in FIG. 15, injecting runners 36B of another embodiment could communicate with the spherical cavity S1, wherein each of the injecting runners 36B includes a guiding section 361 and an injecting section 362. The guiding section 361 communicates with the annular runner 34, and the injecting section 362 communicates with spherical cavity S1. A diameter of the guiding section 361 is greater than a diameter of the injecting section 362. Since the cross-sectional area of each of the injecting sections 362 is smaller than that of the guiding section 361, a design of distribution of the dimple 202a of the golf ball will not be confined by a location of the of the injecting runner 36B, and the gate mark on the outer surface of the golf ball could be reduced. Thus, when the runner system of the injection mold includes the injecting runners 36B of the embodiment shown in FIG. 15, the injection mold is preferable for manufacturing the cover of the golf ball.

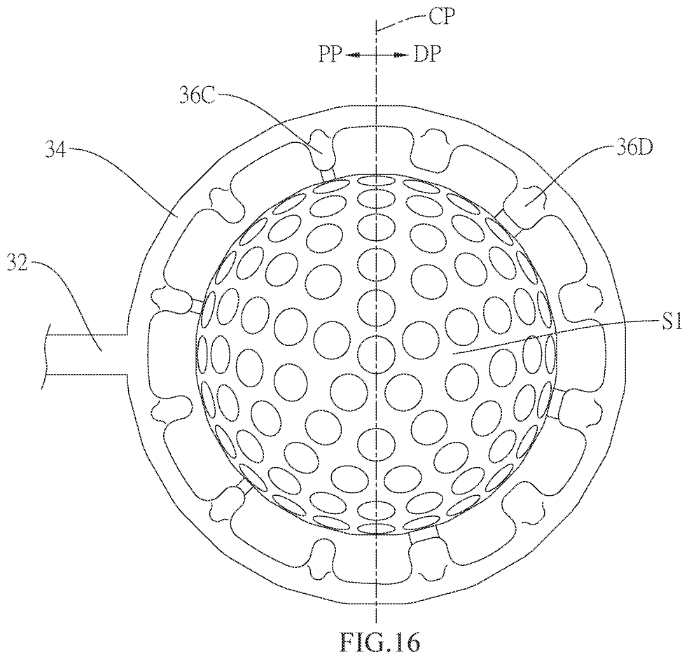

As illustrated in FIG. 16, a distribution of the runner system of an injection mold of another embodiment could also fulfill the condition that the ratio of d/p (namely, a ratio of the area sum (p) of the proximal portion PP to the area sum (d) of the distal portion DP) is greater than 1. A number of injecting runners 36C in the proximal portion PP is equal to a number of the injecting runners 36D in the distal portion DP. A cross-sectional area of each of the injecting runners 36C in the proximal portion PP must be smaller than the cross-sectional area of each of the injecting runners 36D in the distal portion DP. In this embodiment, the number of the injecting runners in the proximal portion PP and the amount of the injecting runners in the distal portion DP are both six. A diameter of each of the injecting runners 36D in the distal portion DP is two times greater than a diameter of each of the injecting runners 36C in the proximal portion PP. Therefore, the ratio of d/p is not only greater than 1, but is actually 2. With such design, the flow volume and speed of the plastic material that flows through the injecting runners 36C (36D) from proximal portion PP and the distal portion DP could be balanced, so that the plastic material could be evenly flow into the spherical cavity S1 to fill the injecting space S2. It is worth to mention that the injecting runners disclosed in this embodiment could be constituted by shallow grooves that completely communicate with the spherical cavity S1. Alternatively, each of the injecting runners disclosed in this embodiment could be constituted by a shallow groove that completely communicates with the spherical cavity S1 and a shallow groove that does not communicate with the spherical cavity S1. Additionally, each of the injecting runners of this embodiment could also include a guiding section and an injecting section.

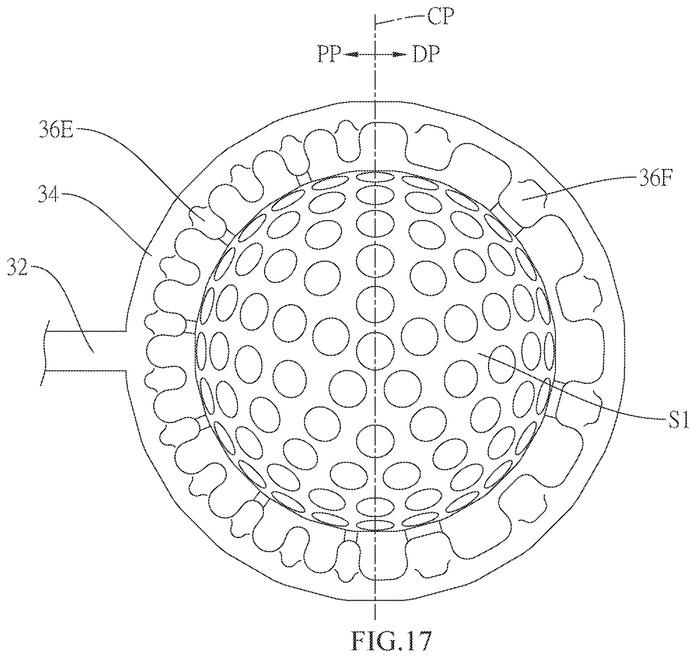

As illustrated in FIG. 17, a distribution of the runner system of an injection mold of another embodiment could also fulfill the condition that the ratio of d/p (namely, a ratio of the area sum (d) of the distal portion DP to the area sum (p) of the proximal portion PP) is greater than 1. A number of injecting runners 36E in the proximal portion PP is greater than a number of the injecting runners 36F in the distal portion DP. However, the cross-sectional area of each of the injecting runners 36E in the proximal portion PP must be smaller than the cross-sectional area of each of the injecting runners 36F in the distal portion DP. In this embodiment, the number of the injecting runners 36E in the proximal portion PP is twelve, and the number of the injecting runners 36F in the distal portion DP is six, wherein a diameter of the injecting runners 36F in the distal portion DP is three times than a diameter of the injecting runners 36E in the proximal portion PP. With such design, the ratio of d/p could be greater than 1, and the flow volume and speed of the plastic material that flows through the injecting runners 36E (36F) from proximal portion PP and the distal portion DP could be balanced, so that the plastic material could be evenly flow into the spherical cavity SI to fill the injecting space S2. Similarly, the injecting runners disclosed in this embodiment could be constituted by shallow grooves that completely communicate with the spherical cavity S1. Alternatively, each of the injecting runners disclosed in this embodiment could be constituted by a shallow groove that completely communicates with the spherical cavity S1 and a shallow groove that does not communicate with the spherical cavity S1. Additionally, each of the injecting runners of this embodiment could also include a guiding section and an injecting section.

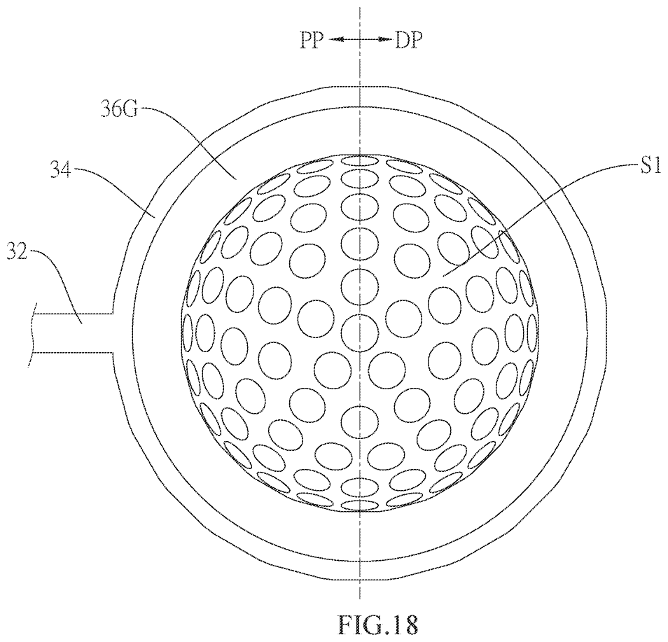

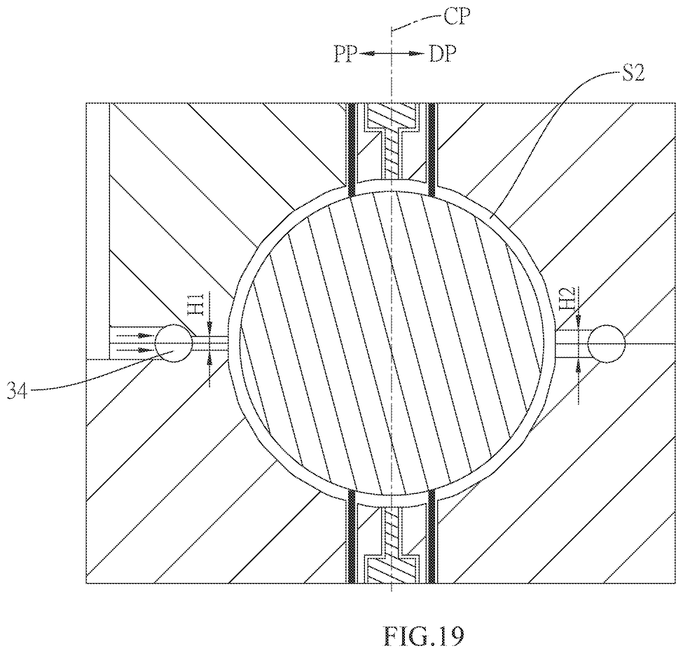

It is worth to mention that the injecting runners in abovementioned embodiments are plural. However, as long as the condition that the cross-sectional area of the injecting runner in the proximal portion is smaller than the cross-sectional area of the injecting runner in the distal portion is fulfilled, the injecting runner of the injection mold could be single. As illustrated in FIG. 18 and FIG. 19, the injecting runner 36G is a radial film gate located at an inner side of the annular runner 34 and surrounds an outer side of the spherical cavity S1. After precise calculation, a first height H1 of the radial film gate corresponding to the injecting runner 36G in the proximal portion PP is smaller than a second height H2 of the radial film gate corresponding to the injecting runner 36G in the proximal portion PP. Additionally, a ratio of d/p (namely, an area sum (d) of the radial film gate corresponding to the distal portion DP to an area sum (p) of the radial film gate corresponding to the proximal portion PP) is greater than 1 is fulfilled. With such design, the plastic material could be steadily and evenly injected through the injecting runner 36G into the spherical cavity S1 to fill the injecting space S2.

Preferably, the extending line L of each of the injecting runners could pass through the center C of the spherical cavity S1. However, in practice, as long as the condition that the sum (p) of the cross-sectional area of the injecting runner in the proximal portion PP is smaller than the sum (d) of the cross-sectional area of the injecting runner in the distal portion DP is fulfilled, the extending line L of each of the injecting runner is not necessary to pass through the center C of the spherical cavity S1.

In the abovementioned embodiments, the phantom coronal plane CP is defined to divide the runner system into the proximal portion PP and the distal portion DP. Based on the definition of the phantom coronal plane CP, the condition that the sum (p) of the cross-sectional area of the injecting runner in the proximal portion PP is smaller than the sum (d) of the cross-sectional area of the injecting runner in the distal portion DP is designed to allow the plastic material to be evenly injected into the spherical cavity and the sprue of the injection molding product to be reduced. In the present invention, a phantom sagittal plane SP could be defined to pass through the injection mold. As illustrated in FIG. 8 and FIG. 10, the phantom sagittal plane SP is perpendicular to the phantom coronal plane CP. Preferably, an intersection between the phantom sagittal plane SP and the phantom coronal plane CP passes through the center C of the spherical cavity S1. The phantom sagittal plane SP divides the first mold half 10 and the second mold half 20 into a first half portion Pl and a second half portion P2. When a sum of the cross-sectional area of the injecting runners 36 in the first half portion Pl is substantially equal to a sum of the cross-sectional area of the injecting runners 36 in the second half portion P2. The plastic material could be steadily and evenly injected through the injecting runners in the first half portion P1 and the second half portion P2 into the spherical cavity S1 to fill the injecting space S2. In order to fulfill the condition that the sum of the cross-sectional area of the injecting runners 36 in the first half portion PI is substantially equal to a sum of the cross-sectional area of the injecting runners 36 in the second half portion P2, the number of the injecting runner 36 in the first half portion Pl is equal to the number of the injecting runner 36 in the second half portion P2. However, the structure that could fulfill the condition that the sum of the cross-sectional area of the injecting runners 36 in the first half portion PI is substantially equal to the sum of the cross-sectional area of the injecting runners 36 in the second half portion P2 is not limited to the abovementioned. The distribution of the runner systems of the abovementioned embodiments could also fulfill the condition that the sum of the cross-sectional area of the injecting runners 36 in the first half portion PI is substantially equal to a sum of the cross-sectional area of the injecting runners 36 in the second half portion P2. The term “substantially equal” mentioned in the current invention means that the difference between the area of the runners may be resulted from manufacturing tolerance. For example, a cross-sectional area N1 of a runner is 0.6100 mm², a cross-sectional area of another runner N2 is 0.6101 mm². There is a difference of 0.0001 mm² between the cross-sectional area N1 of one runner and the cross-sectional area N2 of the another runner. However, the slight difference will not affect the function of the present invention, so that the cross-sectional areas N1, N2 could be treated as substantially equal.

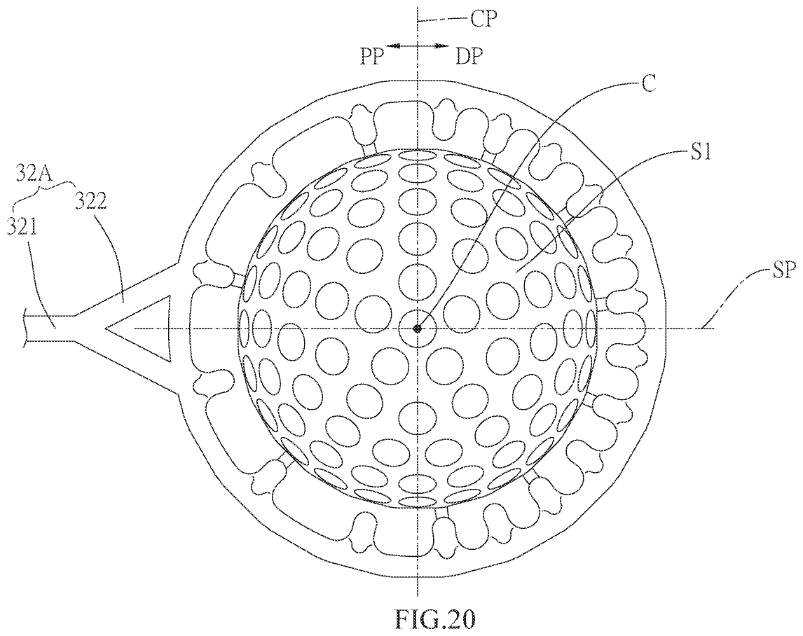

Furthermore, in the aforementioned embodiments, each of the primary runners 32 that corresponds to one of the spherical cavity SI has the extending direction that passes through the center C of the spherical cavity S1. However, the primary runner 32A of the embodiment shown in FIG. 20, includes an injecting section 321 and a V-shaped branching section 322, wherein an extending direction of the injecting section 321 of the primary runner 32A passes through the center C of the spherical cavity S1, wherein the phantom coronal plane CP is perpendicular to the extending direction of the injecting section 321, thereby defining the proximal portion PP and the distal portion DP.

To sum up, the injection mold in the present invention could not only be used for manufacturing the cover of the golf ball, but also be used for manufacturing the intermediate layer of the golf ball. When designing the golf ball with a diameter that is greater than or equal to 42.7 mm, a diameter of the ball body B (namely, the core) and a thickness of the cover should be considered in advance, and then decides a thickness of the intermediate layer. When a diameter of the ball body B is in a range of 19.0 mm to 40.1 mm and a thickness of the cover is in a range of 0.5 mm to 2.0 mm, a thickness of the intermediate layer is better in a range of 0.8 mm to 11.35 mm. Preferably, the thickness of the cover is in a range of 0.6 mm to 1.7 mm. A number of the intermediate layer is not limited to one. The compression deformation of the golf ball manufactured by using the injection mold of the present invention is in a range of 2.2 mm to 4.5 mm. Preferably, the compression deformation of the golf ball is in a range of 2.5 mm to 4.0 mm. The compression deformation means a difference between a deformation amount of the entire golf ball when it is subjected to compressive forces of 10 kg and a deformation amount of the entire golf ball when it is subjected to compressive forces of 130 kg. More particularly, when the golf ball is subjected to the compressive force from 10 kg to 130 kg, the compression deformation is a value that the deformation amount of the golf ball at 130 kg subtracts from the deformation amount of the golf ball at 10 kg. For example, when the golf ball is subjected to the compressive force of 10 kg, the deformation amount of the golf ball is 0.5 mm, and when the compressive force increases to 130 kg, the deformation amount of the golf ball is 5.0 mm. Therefore, the compression deformation of the golf ball is 4.5 mm. This test could be also used for obtaining the compression deformation of a semi-product of the golf ball (such as the core and the intermediate layer).

A golf ball of the embodiment having three-layered structure is illustrated to exemplify a difference between the yield rate of the golf balls that are manufactured by the injection mold of the present invention and the conventional injection mold.

The following description explains the efficacy of the injection molds disclosed in the present invention. Use the injection mold of the present invention and the conventional injection mold to manufacture golf balls having a three-layered structure, and compare the defect rates of the manufactured golf balls. The defect rate means a rate of the defected surface of the manufactured golf balls due to injecting bubbles. The injection molds used to manufacture the golf balls includes a primary runner that corresponds to each of the spherical cavity and is directly connected to the annular runner. The formula of the material that could be used for manufacturing the core, the intermediate layer, and the cover are listed in the following tables. Additionally, the injection molds that are utilized for manufacturing the cover of the golf ball are listed below.

A formula of the material of the core could be selected from table 1. After evenly mixing the material according to the formula mentioned in table 1 by a kneader and a roll mill, the core could be made by compression molding, wherein a temperature of the hot press machine is set at 155° C., and a time of pressing is 18 minutes. A formula of the material of the intermediate layer could be selected from table 2. After evenly mixing the material according to the formula mentioned in table 2, the intermediate layer could be made by injection molding, wherein the temperature of the injection machine is set at 200° C. A formula of the material of the cover could be selected from table 3. After completely drying the material according to the formula mentioned in table 3, the cover could be made by injection molding, wherein the temperature of the injection machine is set at 210° C.

TABLE 1
Rubber compound for manufacturing the core

| Material name | Ratio (PHR) |
|---|---|
| TAIPOL BR0150* | 100 |
| Zinc diacrylate | 27 |
| Zinc oxide | 6 |
| Barium sulfate | 16 |
| Peroxide | 1 |

*TAIPOL BR0150 is a commercial product of cis-1,4-polybutadiene produced by Taiwan Synthetic Rubber Corp.

TABLE 2
Resin blend for manufacturing the intermediate layer

| Material name | Ratio (PHR) |
|---|---|
| Surlyn ® 8940* | 50 |
| Surlyn ® 9910* | 50 |

*Surlyn ®8940 and Surlyn ®9910 are commercial products of ionomer produced by The Dow Chemical Company.

TABLE 3
Resin material for manufacturing the cover

| Material name | Ratio (PHR) |
|---|---|
| TEXIN ® 245* | 100 |

*TREXIN ® 245 is a commercial product of thermoplastic polyurethane produced by Covestro AG.

The injection molds for manufacturing the ball shell layer (namely, the cover) are selected from table 4 and include an injection mold A, an injection mold B, and an injection mold C having the runner system disclosed in the present invention. In other words, the injection mold A, the injection mold B, and the injection mold C fulfill the condition that the sum of the cross-sectional area of the injecting runners in the proximal portion PP is smaller than the sum of the cross-sectional area of the injecting runners in the distal portion DP. An injection mold D has a conventional runner system, wherein the sum of the cross-sectional area of the injecting runners in the proximal portion PP is substantially equal to the sum of the cross-sectional area of the injecting runners in the distal portion.

TABLE 4
Each structural features of the injection molds are listed below.
Structural Features of Injection Mold A

| Number of the injecting runners in the distal portion | 18 | |
|---|---|---|
| Number of the injecting runners in the proximal portion | 6 | |
| Cross-sectional area of each of the injecting runners in | 0.61 | mm² |
| the distal portion | | |
| Cross-sectional area of each of the injecting runners in | 0.61 | mm² |
| the proximal portion | | |
| Sum (d) of cross-sectional area of the injecting runners in | 10.98 | mm² |
| the distal portion | | |
| Sum (p) of cross-sectional area of the injecting runners in | 3.66 | mm² |
| the proximal portion | | |

| | |
|---|---|
| Ratio of d/p | 3 |

Structural Features of Injection Mold B

| Number of the injecting runners in the distal portion | 6 | |
|---|---|---|
| Number of the injecting runners in the proximal portion | 6 | |
| Cross-sectional area of each of the injecting runners in | 1.83 | mm² |
| the distal portion | | |
| Cross-sectional area of each of the injecting runners in | 0.61 | mm² |
| the proximal portion | | |
| Sum (d) of cross-sectional area of the injecting runners in | 10.98 | mm² |
| the distal portion | | |
| Sum (p) of cross-sectional area of the injecting runners in | 3.66 | mm² |
| the proximal portion | | |

| | |
|---|---|
| Ratio of d/p | 3 |

Structural Features of Injection Mold C

| Number of the injecting runners in the distal portion | 6 | |
|---|---|---|
| Number of the injecting runners in the proximal portion | 8 | |
| Cross-sectional area of each of the injecting runners in | 1.20 | mm² |
| the distal portion | | |
| Cross-sectional area of each of the injecting runners in | 0.40 | mm² |
| the proximal portion | | |
| Sum (d) of cross-sectional area of the injecting runners in | 7.20 | mm² |
| the distal portion | | |
| Sum (p) of cross-sectional area of the injecting runners in | 3.20 | mm² |
| the proximal portion | | |

| | |
|---|---|
| Ratio of d/p | 2.25 |

Structural Features of Injection Mold D

| Number of the injecting runners in the distal portion | 6 | |
|---|---|---|
| Number of the injecting runners in the proximal portion | 6 | |
| Cross-sectional area of each of the injecting runners in | 0.61 | mm² |
| the distal portion | | |
| Cross-sectional area of each of the injecting runners in | 0.61 | mm² |
| the proximal portion | | |
| Sum (d) of cross-sectional area of the injecting runners in | 3.66 | mm² |
| the distal portion | | |
| Sum (p) of cross-sectional area of the injecting runners in | 3.66 | mm² |
| the proximal portion | | |

| | |
|---|---|
| Ratio of d/p | 1 |

When the golf ball is designed to include the core having a diameter of 38.7 mm, the intermediate layer having a thickness of 1.1 mm, and the cover having a thickness of 0.9 mm. By utilizing the materials mentioned in table 1 to table 3, the defect rate of the cover of the golf ball manufactured by using each of the injection molds A, B, C, and D are shown in table 5.

TABLE 5
The defect rate of the cover of the golf ball manufactured
by using each of the injection molds A, B, C, and D

| Injection mold | Defect rate |
|---|---|
| Injection mold A | 2% |
| Injection mold B | 3% |
| Injection mold C | 3% |
| Injection mold D | 100% |

From the result shown in table 5, when the golf ball is manufactured by the injection mold having the runner system mentioned in the present invention, wherein the runner system includes the primary runners, the annular runners, and the injecting runners, wherein each of the primary runners corresponds to one of the annular runners, and the injecting runners connected to the annular runner. Additionally, the sum of the cross-sectional area of the injecting runners near the primary runner is smaller than the sum of the cross-sectional area of the injecting runners away from the primary runner. With such design, the flow volume and the speed of the plastic material could be smoothly and evenly injected into the spherical cavity, so that the plastic material will finally be gathered at polar areas and the air could be discharged out from the spherical cavity, thereby promoting the yield rate of the surface of the golf ball.

It must be pointed out that the embodiment described above is only a preferred embodiment of the present invention. All equivalent structures which employ the concepts disclosed in this specification and the appended claims should fall within the scope of the present invention.

What is claimed is:

1. An injection mold for a golf ball, comprising:
a first mold half and a second mold half, wherein each of the mold halves has a parting line surface and at least one inner surface that is recessed into the parting line surface; when the parting line surface of the first mold half is mated with the parting line surface of the second mold half, the inner surface of the first mold half and the inner surface of the second mold half are coupled to form a spherical cavity; and
a runner system comprising a primary runner, an annular runner, and at least one injecting runner, wherein a plastic material flows through the primary runner into the annular runner, and the annular runner is formed on the parting line surface of the first mold half and/or the parting line surface of the second mold half, and the annular runner surrounds the spherical cavity; the at least one injecting runner formed on the parting line surface of the first mold half and/or the parting line surface of the second mold half, and the at least one injecting runner connects between the annular runner and the spherical cavity; an area of a connecting site between the at least one injecting runner and the spherical cavity is defined as a cross-sectional area of the at least one injecting runner;
wherein, a phantom coronal plane is defined to pass through the injection mold to divide the first mold half and the second mold half into a proximal portion and a distal portion; the proximal portion comprises the primary runner and a part of the at least one injecting runner, and the distal portion comprises the other part of the at least one injecting runner; wherein a sum of the cross-sectional area of the at least one injecting runner in the proximal portion is p, and a sum of the cross-sectional area of the at least one injecting runner in the distal portion is d; a ratio of d/p is greater than 1.

2. The injection mold as claimed in claim 1, wherein a phantom sagittal plane is defined to pass through the injection mold, and the phantom sagittal plane divides the first mold half and the second mold half into a first half portion and a second half portion; a sum of the cross-sectional area of the at least one injecting runner in the first half portion is substantially equal to a sum of the cross-sectional area of the at least one injecting runner in the second half portion, wherein the phantom sagittal plane is perpendicular to the phantom coronal plane.

3. The injection mold as claimed in claim 1, wherein the primary runner has an injecting section, and an extending direction of the injecting section is defined to pass through a center of the spherical cavity; the phantom coronal plane is perpendicular to the extending direction of the injecting section.

4. The injection mold as claimed in claim 3, wherein the phantom coronal plane passes through the center of the spherical cavity.

5. The injection mold as claimed in claim 1, wherein the runner system comprises a plurality of injecting runners, and a number of the injecting runners in the proximal portion is smaller than a number of the injecting runners in the distal portion; a cross-sectional area of each of the injecting runners in the proximal portion is substantially equal to a cross-sectional area of each of the injecting runners in the distal portion.

6. The injection mold as claimed in claim 1, wherein the runner system comprises a plurality of injecting runners, and a number of the injecting runners in the proximal portion is equal to a number of the injecting runners in the distal portion; a cross-sectional area of each of the injecting runners in the proximal portion is smaller than a cross-sectional area of each of the injecting runners in the distal portion.

7. The injection mold as claimed in claim 1, wherein the runner system comprises a plurality of injecting runners, and a number of the injecting runners in the proximal portion is greater than a number of the injecting runners in the distal portion; a cross-sectional area of each of the injecting runners in the proximal portion is smaller than a cross-sectional area of each of the injecting runners in the distal portion.

8. The injection mold as claimed in claim 1, wherein the at least one injecting runner is a radial film gate that surrounds the spherical cavity.

9. The injection mold as claimed in claim 2, wherein the at least one injecting runner is a radial film gate that surrounds the spherical cavity.

10. An injection mold for a golf ball, comprising:
a first mold half and a second mold half, wherein each of the mold halves has a parting line surface and at least one inner surface that is recessed into the parting line surface; when the parting line surface of the first mold half is mated with the parting line surface of the second mold half, the inner surface of the first mold half and the inner surface of the second mold half are coupled to form a spherical cavity; and
a runner system comprising a primary runner, an annular runner, and a plurality of injecting runners, wherein a plastic material flows through the primary runner into the annular runner, and the annular runner is formed on the parting line surface of the first mold half and/or the parting line surface of the second mold half, and the annular runner surrounds the spherical cavity; the plurality of injecting runners formed on the parting line surface of the first mold half and/or the parting line surface of the second mold half, and the plurality of injecting runners connect between the annular runner and the spherical cavity;
wherein, a phantom coronal plane is defined to pass through the injection mold to divide the first mold half and the second mold half into a proximal portion and a distal portion; a number of the injecting runners in the proximal portion is smaller than a number of the injecting runners in the distal portion, and the proximal portion comprises the primary runner.

11. The injection mold as claimed in claim 10, wherein a sum of the cross-sectional area of the injecting runners in the proximal portion is smaller than a sum of the cross-sectional area of the injecting runners in the distal portion.

12. The injection mold as claimed in claim 11, wherein a phantom sagittal plane is defined to pass through the injection mold, and the phantom sagittal plane divides the first mold half and the second mold half into a first half portion and a second half portion; a sum of the cross-sectional area of the injecting runners in the first half portion is substantially equal to a sum of the cross-sectional area of the injecting runners in the second half portion, wherein the phantom sagittal plane is perpendicular to the phantom coronal plane.

13. The injection mold as claimed in claim 10, wherein an area of a connecting site between each of the plurality of injecting runners and the spherical cavity is defined as a cross-sectional area of the injecting runner.

14. The injection mold as claimed in claim 13, wherein an extending line of each of the injecting runners passes through a center of the spherical cavity.

15. A golf ball, comprising a core and a cover that covers the core, wherein the golf ball is characterized in that the cover is manufactured by using the injection mold as claimed in claim 1.

16. The golf ball as claimed in claim 15, wherein an outer surface of the cover has a plurality of dimples, and a thickness of the cover is in a range of 0.5 mm to 2.0 mm.

17. The golf ball as claimed in claim 16, comprising at least one intermediate layer that is located between the core and the cover, wherein a thickness of the at least one intermediate layer is in a range of 0.8 mm to 11.35 mm.

18. The golf ball as claimed in claim 17, wherein the at least one intermediate layer is manufactured by the injection mold as claimed in claim 1.

19. The golf ball as claimed in claim 17, wherein an outer surface of the at least one intermediate layer is unsmooth.

20. The golf ball as claimed in claim 15, wherein a compression deformation of the golf ball is in a range of 2.2 mm to 4.5 mm.
